(19) United States
(12) Patent Application Publication
(10) Pub. No.: US 2003/0073413 A1
(43) Pub. Date: Apr. 17, 2003

(54) Bag for a mobile phone

(76) Inventor: Ming-Chi Huang, Taipei (TW)

Correspondence Address: CONNOLLY BOVE LODGE & HUTZ, LLP, 1220 N MARKET STREET, P O BOX 2207, WILMINGTON, DE, 19899

(21) Appl. No.: 09/978,468

(22) Filed: Oct. 17, 2001

(51) Int. Cl. H04B 1/38

(52) U.S. Cl. 455/90; 455/66; 455/351

(57) ABSTRACT

A bag for a mobile phone with a function of sealing is made of soft plastic material treated by way of high frequency thermo-bonding technique to form an air sac surrounding a transparent part. As soon as the air sac is filled with the air, the air sac swells and encloses the mobile phone contained in the bag so as to perform excellent shock mitigation after collision or falling down. Furthermore, the entire bag for a mobile phone can float on the water level while the user takes outdoor or aquatic activities so that it can provide an extremely good water resistance.

### BACKGROUND OF THE INVENTION

1. Field of the Invention

The present invention relates to a bag for receiving and sealing a mobile phone, and particularly to a bag, which provides a surrounding air sac to offer an excellent shock mitigation for a mobile phone received and sealed therein.

2. Description of Related Art

Due to the mobile phone is convenient for us to communicate with others, it becomes getting popular year after year and more people are accustomed to carry about with them a mobile phone. It is believed that most of the users have an experience of missing a chance to answer a phone caused by not hearing the ringing of the mobile phone placed in the handbag. Although the mobile phone being attached to the waist may overcome the defect of being unable to hear the ringing emitted by the mobile phone in the handbag clearly, the mobile phone at the waist makes the user feel uncomfortable. Accordingly, a bag receiving a mobile phone and being hung over in front the chest is developed. The mobile phone bag basically is a receiving bag 171 as shown in FIG. 8 with a filling clip 17 or with a primary clamp part 181 and a secondary clamp part so as to be clamped by way of a screw sleeve 183 as shown in FIG. 9. While in use, the clip or the clamp parts can clamp the receiving bag 171 tightly as soon as the mobile phone is placed in the receiving bag 171. Further, the clamped receiving bag 171 can be hung over in front of the chest once a hanging tie is arranged to pass through the bag 171. Although the prior art basically can provide a hanging function but a disadvantage still gets involved therein. The prior art is unable to well protect the mobile phone from the water, mud with sand, or collision, which is touched frequently while an outdoor leisure activity is performed in our daily life. In addition, the prior art is not so handy in operation and the reliability with regard to the function of clamping the bag is still not so sufficient.

### SUMMARY OF THE INVENTION

In order to improve the forgoing shortcomings of the conventional bag for a mobile phone, the present inventor has endeavored in a deeper investigation and has developed the present invention, which is simple in use with a reliable effect.

Accordingly, the main object of the present invention is to provide a bag for a mobile phone, which is possible to receive and seal the mobile phone with an air sac surrounding the mobile phone such that the bag can offer a better protective mitigation against collision or falling down as soon as the air sac is filled with the air.

Another object of the present invention is to provide a bag for a mobile phone, which is possible to float on the water level during a user conducting an outdoor or a aquatic activity.

### BRIEF DESCRIPTION OF THE DRAWINGS

The present invention can be more fully understood by reference to the following description and accompanying drawings, in which:

FIG. 1 is a perspective view of a bag for a mobile phone according to the present invention;

FIG. 2 is a perspective view illustrating the bag for a mobile phone shown in FIG. 1 in a state of being stretched out;

FIG. 3 is a perspective view illustrating the bag for a mobile phone shown in FIG. 3 in a state of being ready for use;

FIG. 4 is a perspective view illustrating a mobile phone being put in the bag for a mobile phone shown in FIG. 3;

FIG. 5 is a perspective view illustrating a mobile phone having been received in the bag of the present invention;

FIG. 6 is a sectional view of the bag for a mobile phone according to the present invention;

FIG. 7 is a perspective view similar to FIG. 5 illustrating the bag of the present invention having been filled with the air;

FIG. 8 is a perspective view of a conventional bag for a mobile phone; and

FIG. 9 is a perspective view of another conventional bag for a mobile phone.

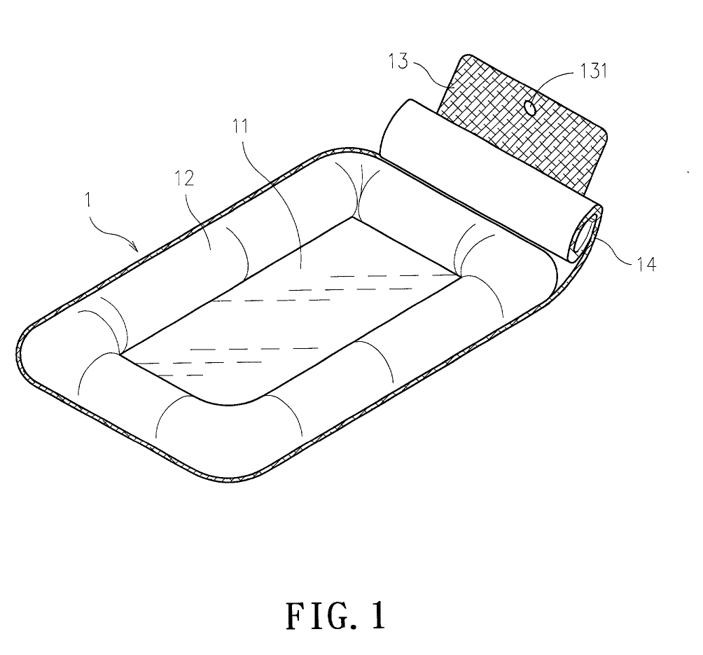

### DETAILED DESCRIPTION OF THE PREFERRED EMBODIMENT

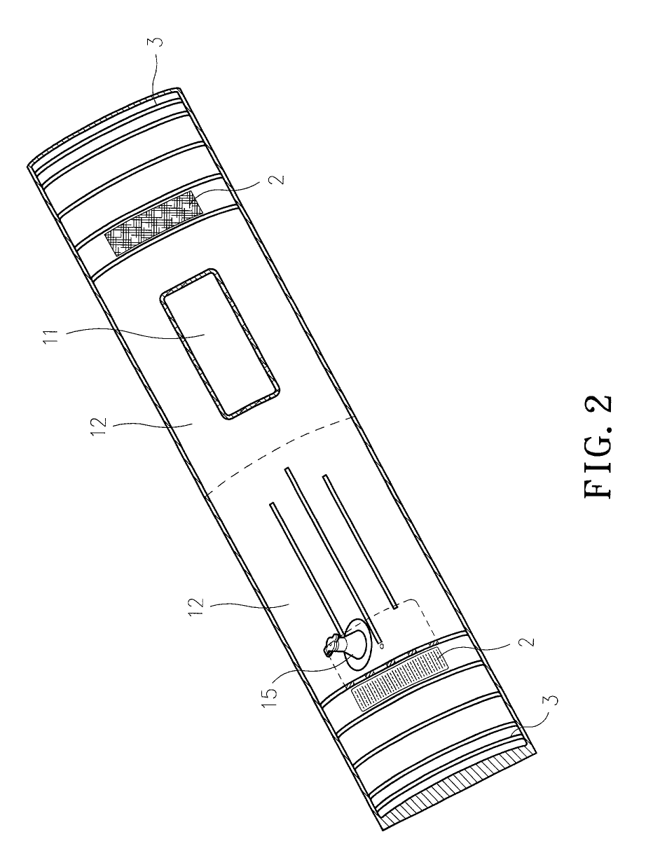

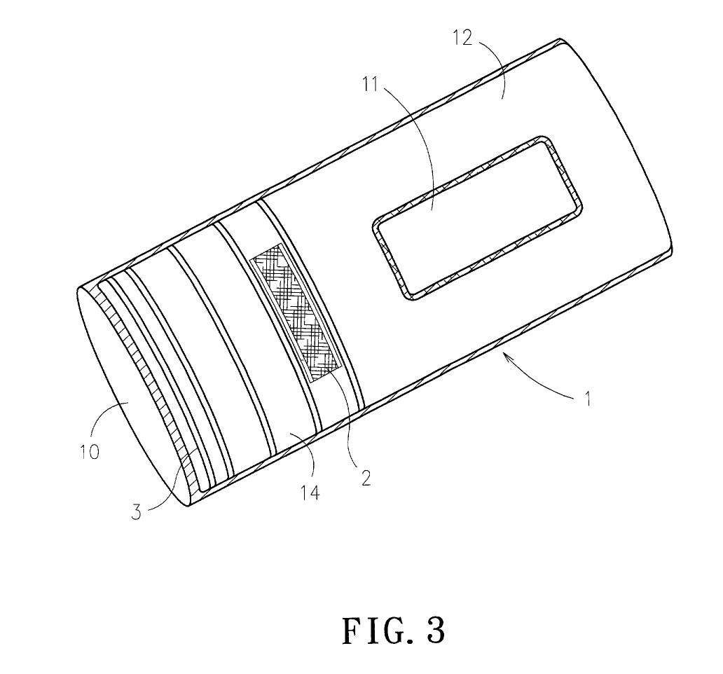

Referring to FIG. 2, a bag for a mobile phone according to the present invention is made of soft plastic material and two layers of the material are bonded by way of high frequency thermo-bonding technique to form an expected configuration of bag blank. The bag blank is then folded into two halves and both lateral sides of the folded bag blank are bonded by way of thermo-bonding technique again to constitute a bag 1 for a mobile phone with a receiving room 10. The bag 1 at the middle part thereof provides a transparent area 11 and an air filling part 12 surrounds the transparent area 11 with a blowing inlet 15 disposed at the rear side of the bag 1. A chain clip 3 is provided at the opening of the bag 1 and a detachable part 14 is arranged behind the chain clip 3 with a hook and loop fastener band 2 being disposed oppositely at the facial side and the rear side thereof respectively for being fixedly attached to the foldable part 14 after the bag 1 being closed. A hanging plate 13 with a hanging hole 131 thereon is provided at the back of the hanging plate 13.

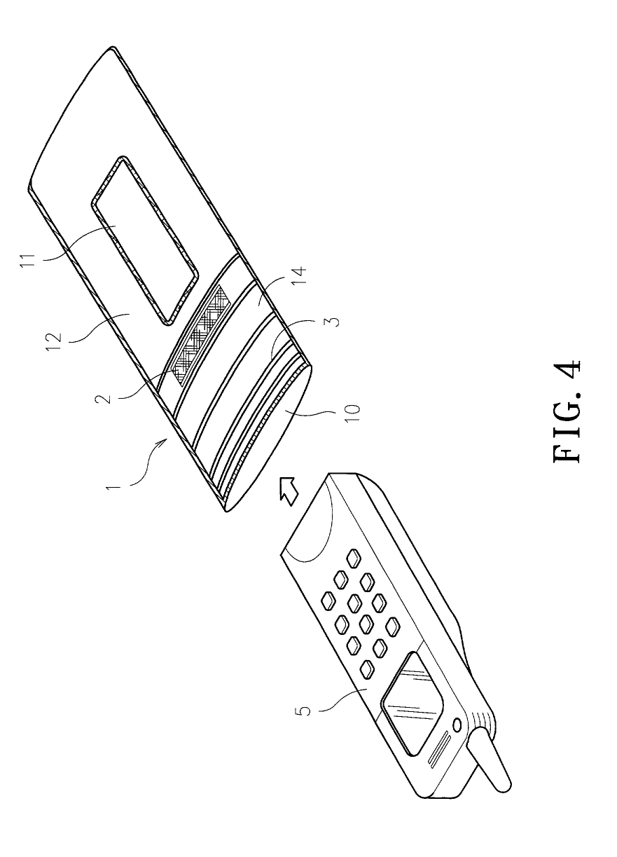

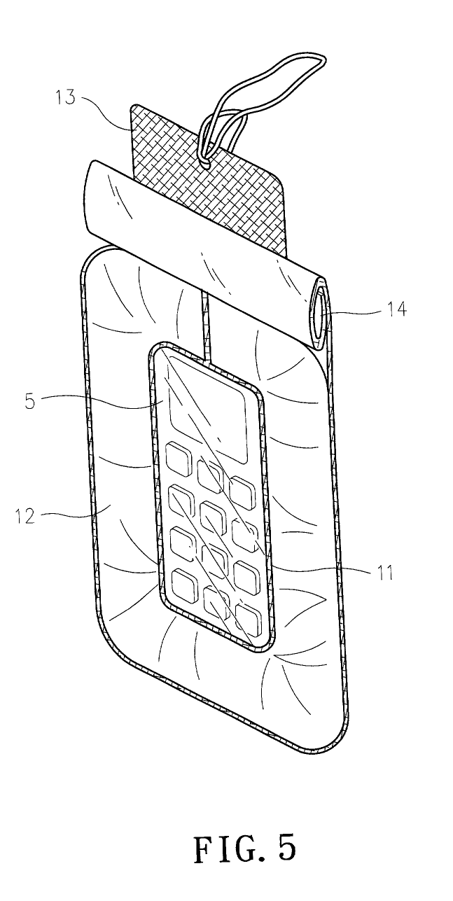

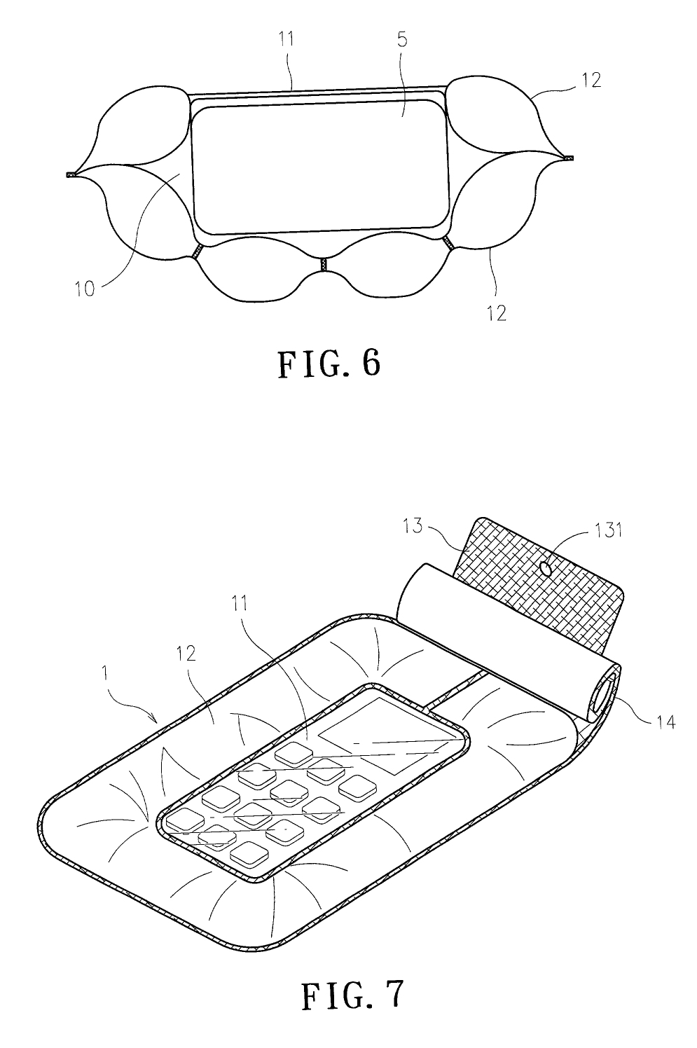

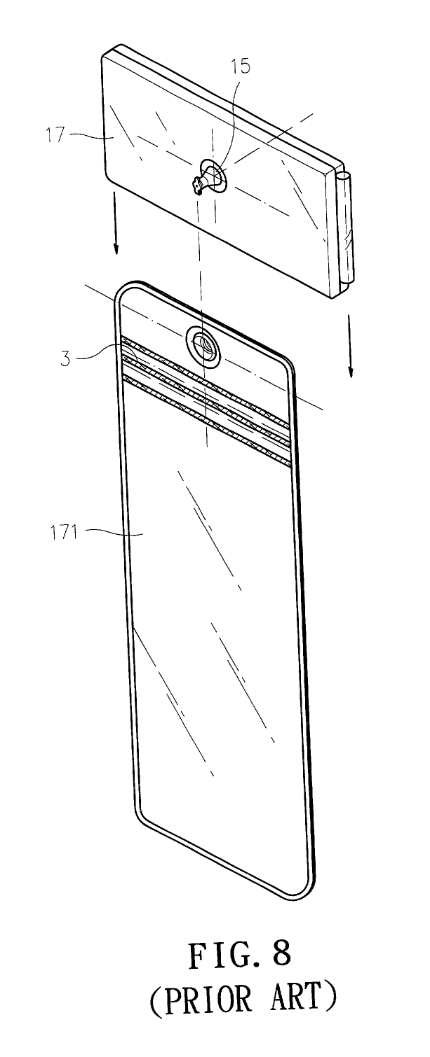

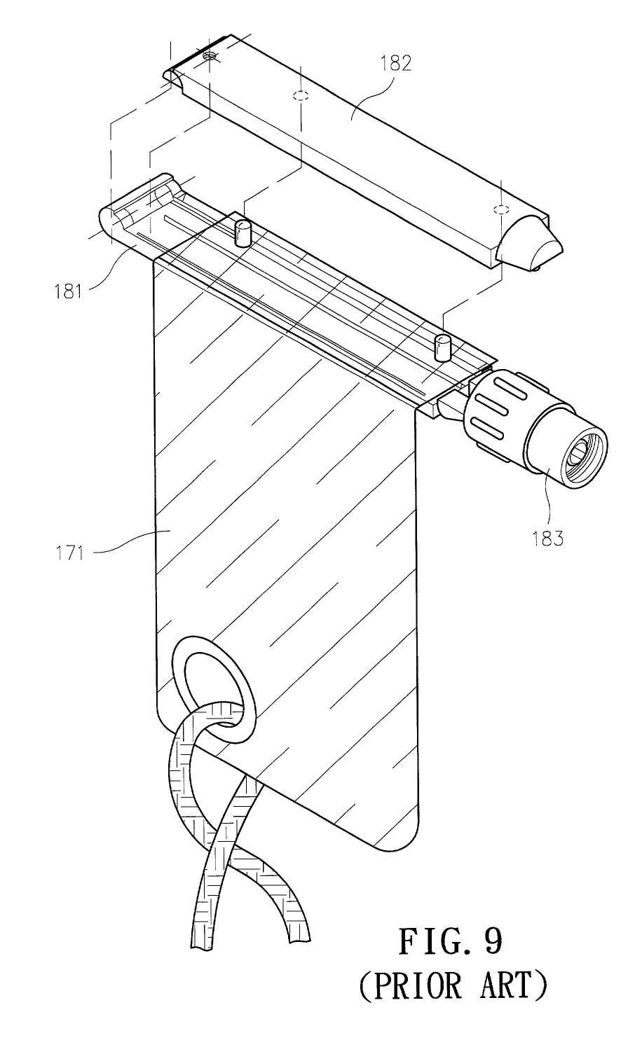

The bag 1 according to the present invention has the receiving room 10 and the mobile phone 5 can be inserted into the receiving room 10 as shown in FIG. 4. The transparent part 11 at the middle area of the bag 1 is possible for the screen and button keys of the mobile phone 5 in the bag 1 being read clearly as shown in FIG. 5. The blowing inlet 15 at the rear side of the bag 1 can admit the air so that the air filling part 12 of the bag 1 can swell to form an air sac surrounding the mobile phone 5 as the end sectional view in FIG. 6 illustrates.

Further, the chain clip 3 provided at the opening of the bag 1 can keep the opening in a state of closing and result in the closed part being bent inward to form the foldable part 14. The hook and loop fastener bands 2 can be fixedly adhered with each other such that the mobile phone can be sealed in the bag 1. Finally, a hanging belt can be arranged to pass over the hanging hole 131 of the hanging plate so that the bag 1 is possible to be attached to a proper place.

It is clear from the forgoing that the bag for a mobile phone of the present invention performs the job of receiving and protecting the mobile phone. Even more, it is possible to prevent the mobile phone from contacting the water as it is expected. Therefore, it is appreciated that the present invention overcomes the disadvantage involved in the conventional art reliably.

While the invention has been described with reference to preferred embodiments thereof, it is to be understood that modifications or variations may be easily made without departing from the spirit of this invention which is defined by the appended claim.

What is claimed is:

1. A bag for a mobile phone made of soft plastic material, comprising:
two layers of the material, being treated with high frequency thermo-bonding technique to form a specific shape with a receiving room and an opening;
characterized in that the two bonded layer provides a facial side with a middle transparent area, an air filling part surrounding the transparent area, a rear side filled with a filling inlet, and a chain clip at the opening; a foldable part is arranged behind the chain clip with two hook and loop fastener band being fixedly attached to the facial side and the rear side respectively such that the two hook and loop fastener band can adhere firmly after the foldable part being folded, and a hanging plate is disposed at the back of the foldable part with a hanging hole.
